(19) United States
(12) Patent Application Publication
(10) Pub. No.: US 2002/0012759 A1
(43) Pub. Date: Jan. 31, 2002

(54) Molding base paper and molded paper vessel produced from it

(75) Inventors: Yoshiyuki Asayama, Tokyo (JP); Hideyuki Mikado, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: OJI PAPER CO., LTD., Chuo-ku (JP)

(21) Appl. No.: 09/867,629

(22) Filed: May 31, 2001

(30) Foreign Application Priority Data
May 31, 2000 (JP) 2000-162889
May 31, 2000 (JP) 2000-162890
Oct. 3, 2000 (JP) 2000-341167
Oct. 23, 2000 (JP) 2000-323065

(51) Int. Cl. B32B 1/02

(52) U.S. Cl. 428/34.2

(57) ABSTRACT

A molding base paper used for forming paper vessels such as a cup or tray for foods and various industrial products is disclosed which satisfies the following conditions (1) to (4):

(1) a tensile strength (JIS-P 8113) of at least 2.0 kN/m,

(2) an elongation at break (JIS-P 8113) of at least 1.5%,

(3) a critical compression stress, defined by the following formula, in the range of 1 to 10 MPa:

critical compression stress=A/B

wherein A represents the compression strength determined by JIS-P 8126, and B represents the area of loaded part of the test piece in the determination of the compression strength, and

(4) an amount of the compression deformation, caused by applying compression stress of 20 kgf/cm²in thickness direction, of at least 10 %.

The paper vessels are prepared by controlling the water content of the molding base paper at 10 to 20% and then drawing the molding base paper at 100 to 150° C.

### BACKGROUND OF THE INVENTION:

The present invention relates to a molding base paper, which is used as a material for various packing vessels for industrial products or the like. The vessels are also usable for keeping fresh foods such as meats, vegetables and fishes, and various processed foods such as lunches, side dishes, frozen foods, cakes and noodles. In particular, the present invention relates to a molding base paper, which causes only a low environmental load upon disposal and which is particularly suitable for press molding.

Plastic vessels have been used in a large amount as food vessels or packing materials for various industrial products because they can be easily molded, they can be mass-produced and the production costs of them are low.

Examples of the plastic vessels widely used are foamed styrol vessels obtained by molding foaming polystyrene beads or by press-molding foaming polystyrene sheets; polypropylene vessels, polyethylene terephthalate vessels and polyvinyl chloride vessels.

However, these plastic vessels have a problem in that, when they are thrown away, the environment is burdened with a heavy load. Namely, when the plastic vessels are buried in the ground, they are semipermanently kept in the ground without being decomposed. Further, when they are incinerated, the incinerator is damaged because of a high incineration calorie thereof; they cannot be easily and perfectly combusted and particularly, when polyvinyl chloride is incinerated, gaseous hydrogen chloride having a strong corroding effect might be formed.

Under these circumstances, recyclable, biodegradable vessels made of a pulp causing only a low environmental load, and having only a low incineration calorie are recently demanded in place of the plastic vessels, taking the environmental problems, recycling problems and saving of resources into consideration.

As for three-dimensional moldings made of pulp only or a material mainly comprising pulp, pulp molded vessels have been used.

The pulp molded vessels have been widely used as packing vessels. The pulp molded vessels were produced by a method which comprises preparing a net mold having concave and convex corresponding to the shape of the intended vessel, making paper using a pulp slurry on the net mold under suction and drying it. By this method, the starting pulp material can be molded in a desired shape. Thus, the vessel obtained by this method has a shape which can be selected in a considerably wide range. However, the production of the pulp mold takes a time and it has a problem in the productivity.

Further, it is difficult to impart sufficient water resistance and oil resistance, which are often demanded of tray vessels for foods, to the pulp molded vessels. This technique increases the cost.

For the production of moldings mainly composed of pulp other than pulp moldings, a process wherein a base sheet mainly composed of pulp such as a paperboard is press-molded under heating.

In this method, the base sheet having score lines is placed between male and female molds and then pressed under heating.

This press molding method has a very high productivity because the molding can be obtained by one pressing operation.

However, the base sheet mainly composed of paper pulp generally has poor drawing property, extensibility and elasticity unlike resins and metals. Therefore, when a deep press molding is conducted for the purpose of obtaining a tray having a certain deepness, such as 40 mm or deeper, the base sheet cannot bear the drawing and might be broken.

Thus, when an ordinary board paper or the like was used as the base material, only shallow vessels, so-called paper plates having a deepness as shallow as 20 mm, could be produced. Thus, the shape of the obtained moldings was limited in the prior art.

In addition, even when the vessels were not broken, the folds at the score lines become uneven and the vessel surface cannot be easily smoothened. In case the flange or rim of a tray, which extends horizontally and outwardly from the upper edge of the side wall of the tray, is uneven, a gap is formed due to the unevenness when the tray is covered with a lid or when it is sealed with a film or the like and accordingly the sealing is lowered. Further, a breaking point at the fold causes of lowering of the strength of the tray.

Methods for solving those problems were proposed. For example, Japanese Patent (hereinafter referred to as “J. P”) KOKAI No. Hei 5-286023 discloses a method wherein a corrugated paper prepared by providing many bent portions on a paper material in a wave form to make it extensible is compressed in a mold under heating; J. P. KOKAI No. Hei 6-134898 discloses a method wherein a paper material having the whole concavo-convex surface to make it extensible is moistened and then press-molded under heating; and J. P. KOKAI No. Hei 7-214705 discloses a method wherein two or more sheets of moistened base paper are laminated by means of an adhesive, and the obtained laminate is corrugated and then press-molded.

In all of these methods, however, the base sheets are previously corrugated and thereby made extensible so that press-processability is imparted to them and, then they are pressed. Thus, the corrugation step is necessitated before the pressing step and the corrugation still remains in the pressed vessel to impair the appearance of the vessel and also to make the strength of the vessel insufficient.

J. P. KOKAI No. Hei 7-315358 discloses a method wherein a corrugated sheet is pressed under heating in a metal mold. In this method, the corrugated sheet is used as the base material so that a distortion caused by the pressing is absorbed to some extent by the fluted structure thereof.

However, this method, wherein the corrugated sheet should be used as the base sheet, cannot be employed when an ordinary base material such as a paperboard is used. In addition, the creases caused by the pressing cannot be completely removed.

J. P. KOKAI Hei 6-239334 discloses a method wherein pulp fibers are impregnated with an olefin resin, a sheet thus having extensibility is obtained from the mixture and then the sheet is pressed. J. P. KOKAI Hei 10-8393 discloses a method wherein a sheet having an improved extensibility is obtained from a mixture of thermoplastic resin fibers and pulp fibers and then the sheet is pressed under heating.

However, these methods are to impart press processability to the base sheet mainly comprising paper by adding the thermoplastic resin thereto. These references do not disclose to impart press processability to the base sheet by controlling the physical properties of the base paper and by constituting the specific layer structures. In addition, the use of the thermoplastic resins in a large amount may result in a large problem in lowering recyclability and increasing the environmental load when it is thrown away.

The base sheets obtained by the above-described methods have the following defect: When a molding obtained by pressing them under pressure has a curved part of a serious distortion, the unevenness of the creases is serious in the curved part and it cannot be removed by the pressing. The moldability was thus not good.

When vessels are to be used for moist foods, drinks, soups and noodles in soup, and for various other purposes, molded plastic vessels having side walls higher than those of the tray-shaped vessels and cup-shaped molded vessels are used.

### BRIEF DESCRIPTION OF THE DRAWINGS

FIG. 1 shows a flow diagram which shows how to mold a paper blank sheet 3 by a pair of molds 1, 2.

FIG. 1A shows the state where a blank paper sheet is set on a female mold before the pressing.

FIG. 1B shows the state where a paper molded product exists on the concave portion of the female mold after the pressing.

FIG. 2 is a perspective view of a paper tray showing the shape of one example of the paper vessels.

FIG. 3 a perspective view of a paper tray showing the shape of a different example of the paper vessels.

FIG. 4 is a cross-sectional view of a paper tray taken along the line a-a in FIG. 2 or line b-b in FIG. 3, wherein a taper angle (φ) and a radius of curvature (r) are shown.

FIG. 5 is a perspective view of a paper tray having a round bottom.

FIG. 6 is a cross-sectional view of a paper tray, wherein a projected bottom area (S3) of the tray is indicated.

FIG. 7 is a cross-sectional view of a paper tray having a round bottom, wherein a virtual bottom area (S4) of the tray is indicated.

FIG. 8 shows a plan view of a blank sheet wherein score lines are formed both sides.

FIG. 9 shows a perspective view of a molded vessel using the blank sheet shown in FIG. 8.

FIG. 10 shows perspective views of a rectangular molded vessel obtained in Example 3-1 taken from different angles.

FIG. 11 shows perspective views of a square molded vessel obtained in Example 3-2.

FIG. 12 shows perspective views of a round molded vessel obtained in Example 3-3.

FIG. 13 shows perspective views of a round molded vessel obtained in Example 4.

### SUMMARY OF THE INVENTION

The object of the present invention is to provide a base paper suitable for press molding. The base paper mainly comprises a pulp and it also has such an excellent moldability in that the base material is not easily cracked and no unevenness is formed on the creased parts at the folding parts in the pressing step, and has a high productivity.

Another object of the present invention is to provide paper vessels produced by a drawing method (deep drawing vessel) and usable as relatively deep trays and cups, such as those having a depth of 40 mm or higher, and a method for producing them.

Still another object of the present invention is to provide paper vessels produced by the deep drawing method, which are light in weight and free from swelling at the body and bottom thereof and which also have a high stiffness.

For attaining the above-described objects, the present invention provides a molding base paper satisfying the following conditions (1) to (4):

(1) a tensile strength (JIS-P 8113) of at least 2.0 kN/m,

(2) an elongation at break (JIS-P 8113) of at least 1.5%,

(3) a critical compression stress, defined by the following formula, in the range of 1 to 10 MPa:

Critical compression stress=A/B

wherein A represents the compression strength determined by JIS-P 8126, and B represents the area of loaded part of the test piece in the determination of the compression strength, and

(4) an amount of the compression deformation, caused by applying compression stress of 20 kgf/cm² in thickness direction, of at least 10%.

The present invention also provides a molding base paper having a high-density layer having a density of 0.7 to 0.9 g/cm³ and a low-density layer having a density of lower than 0.7 g/cm³, and also having a whole basis weight of 100 to 500 g/cm² and a whole density of 0.4 to 0.7 g/cm³, wherein the low-density layer is mainly composed of at least one pulp selected from among mechanical pulps, curled fibers and mercerized pulps.

### DESCRIPTION OF THE PREFERRED EMBODIMENTS

Natural pulp fibers for forming the molding base paper according to the present invention are, for example, wood fibers (chemical pulps and mechanical pulps), non-wood fibers and waste paper pulps. They are suitably selected as required.

The wood fibers include fibers from coniferous trees and broad leaf trees. Among the wood fibers, the chemical pulps include kraft pulps produced by using sodium hydroxide and sodium sulfide in the step of digesting wood chips, and also sulfite pulp produced by using a sulfurous acid and a hydrogensulfite. These pulps may be either unbleached or bleached.

Such kraft pulps include coniferous kraft pulps and broad leaf kraft pulps. Depending on whether the pulps are bleached or unbleached, the pulps can be classified into bleached kraft pulps such as coniferous bleached kraft pulps (NBKP) and broad leaf bleached kraft pulps (LBKP) and unbleached kraft pulps such as coniferous unbleached kraft pulps (NUKP) and broad leaf unbleached kraft pulps (LUKP).

The mechanical pulps include ground wood pulp (GP) obtained by grinding logs with a grinder, refiner ground wood pulp (RGP) obtained by refining waste woods from lumbermills, and thermomechanical pulp (TMP) obtained by heating and refining wood chips.

In those mechanical pulps, TMP is preferred in view of the bulkiness and strength of the resultant sheets. TMP also includes C-TMP obtained by the chemical treatment of the wood chips followed by the refining under pressure, and BC-TMP obtained by additional bleaching treatment.

It is preferable that TMP is generally used in an amount of 10 to 100%, more preferably 20 to 80% on the basis of the mass of the pulp of the molding base paper.

In those wood fiber pulps, those having long fibers obtained from conifers such as pine, larch, cedar, fir and Japanese cypress are suitable for improving the extensibility and strength of the base papers.

Pulps of short fibers obtained from broad leaf trees such as birch, beech, maple, elm and chestnut trees are also usable in combination with the trees of long fibers so far as the effect of the present invention is not imp aired.

Non-wood fibers usable in the present invention include bast fibers such as paper mulberry, paper bush, ganpi, flax, hemp, kenaf, ramie, jute and Sunn hemp; seed fibers such as cotton and cotton linters; leaf fibers such as Manila hemp, sisal and esparto; and stem fibers such as bamboo, rice straw, wheat straw and sugarcane bagasse.

In particular, paper mulberry, paper bush, kenaf, Manila hemp, sisal, cotton and cotton linters are preferred because they have long fibers and they are capable of improving the extensibility and strength of the base paper of the present invention.

The non-wood fibers can be digested in the same manner as that for the wood fibers.

The waste paper pulps usable in the present invention include, for example, waste corrugated papers and papers of waste magazines. The waste corrugated papers are particularly preferred because they are capable of improving the extensibility and strength of paper sheets.

These pulp fibers are usable either alone or in combination of two or more kinds of them.

If necessary, synthetic resin fibers can be mixed with the fibers so far as the effect of the present invention is not impaired. The synthetic resin fibers usable herein are, for example, polyethylene fibers, polypropylene fibers, polyamide fibers, polyethylene terephthalate fibers and polybutylene terephthalate fibers. However, the amount of the synthetic fibers to be used should be as small as possible in view of the recycling property of the molding base paper and of lowering the environmental load. For example, if used, it would be suitable that the amount would be up to 10%, based on the total fibers in the molding base paper.

The molding base paper, made of the above-described pulp fibers, preferably has a tensile strength (JIS-P 8113) of at least 2.0 kN/m. The molding base paper preferably has an elongation at break (JIS-P 8113) of at least 1.5%, more preferably at least 2.0%. When the molding base paper has a tensile strength of less than 2.0 kN/m or an elongation at break of lower than 1.5%, the extensibility of the base paper is low and the base paper is broken at the time of press molding.

The properties of the base paper can be controlled in these ranges by known methods such as a method wherein the base paper is prepared in a plural layers and at least one of these layers is made of NBKP or a method wherein a strength additive is incorporated thereinto.

When the press mold has a curved part of a high distortion (or larger curvature), it is necessary to absorb the distortion by forming folding creases in the curved part in the press-molding step. In this case, the creased part is tucked like an accordion in the plane direction to form an uneven surface and then the uneven surface is compressed in the thickness direction by the pressing. Therefore, for obtaining a higher moldability, it is preferred to control the critical compression stress as determined by the following formula in the range of 1 to 10 MPa, preferably 3 to 9 MPa and the compressibility in the thickness direction is 10% or higher, preferably 15% or higher. In this case, the term “compressibility” means that in a thickness direction when a compression stress of 20 kgf/cm² is imposed.

Critical compression stress=A/B

wherein A represents the compression stress determined by JIS-P 8126, and B represents the area of loaded part of the test piece in the determination of the compression strength.

When the critical compression stress is larger than 10 MPa, the creased part is not sufficiently tucked. When the compressibility is lower than 10%, the compression molding in the creased part becomes insufficient. Thus, the excellent moldability cannot be obtained in these cases.

For controlling the critical compression stress and the compressibility in the thickness direction in the above-described ranges, the density of the molding base paper should be kept low. For this purpose, rigid pulp fibers are preferred. Generally, pulp fibers are beaten to obtain a paper sheet having a uniform formation (namely, a mechanical external force is applied to the pulp fibers to partially fibrillate the cellular walls of the fibers). However, in the present invention, the beating should be controlled to be light so as to keep the stiffness of the fibers. For example, the degree of the beating is preferably controlled so that the freeness (Tappi T-227 Canadian standard) of chemical pulps should be at least 500 mlcsf, that of mechanical pulps should be at least 180 mlcsf, that of hemp pulp and kenaf should be at least 500 mlcsf and that of waste corrugate paper pulp should be at least 500 mlcsf. For beating the pulp fibers, a beater, conical refiner, drum-type refiner, disc-type refiner or the like is used.

A foaming agent can be incorporated into the molding base paper to lower the density thereof so far as the effect of the present invention is not impaired.

Heat-expanding microcapsules containing a low-boiling solvent can be used as the foaming agent. The microcapsules are in the form of particles having an average diameter of 10 to 30 μm, which expand to about 4 to 5 times larger diameter and about 50 to 100 times larger volume by heating to a relatively low temperature of 80 to 200° C. for a short period of time. Each microcapsule comprises a volatile organic solvent (expanding agent) such as isobutane, pentane, petroleum ether, hexane, a low-boiling halogenated hydrocarbon or methylsilane covered with a thermoplastic resin comprising a copolymer of vinylidene chloride, acrylonitrile, an acrylic ester, etc. When the capsules are heated to a temperature above the softening point of the polymer, the polymer membrane starts to be softened and gradually the vapor pressure of the expanding agent contained therein is elevated to expand the membrane and thereby to expand the capsules. The foaming agent is added to a pulp slurry and foams in the heating and drying step in the production of the molding base paper or the foaming agent foams when the molding base paper containing it is passed through water having a high temperature. Further, light pigments such as shirasu balloons can be added to the pulp slurry to lower the density of the base paper in the step of making it.

Chemicals usable for producing the base paper of the present invention are sizing agent, strength additive, yield improver, etc. which are the same as those usually used for making paper. They are usable if necessary.

The sizing agents usable herein include inner sizing agents such as alkyl ketene dimers, styrene/acrylic resin and rosin. The strength additives and yield improvers include organic compounds such as polyacrylamide resin, polyamide epichlorohydrin resin, polyethyleneimine and derivatives thereof, polyethylene oxide, polyamine, polyamide, polyamide polyamine and derivatives thereof, cationic and amphoteric starches, oxidized starch, carboxymethylated starch, vegetable gum and polyvinyl alcohol; and inorganic compounds such as alumina sulfate, alumina sol, colloidal silica and bentonite. They can be used in a suitably combined form.

These additives can be added by spraying between the paper layers in the paper making step or by applying them to the base paper surface in the course of or after making the paper.

A filler can be used in the course of making paper in the present invention. The fillers include inorganic fillers such as talc, kaolin, calcined kaolin, clay, diatomite, heavy calcium carbonate, magnesium carbonate, aluminum hydroxide, titanium dioxide, magnesium sulfate, silica, aluminosilicates and kaolin; and organic synthetic fillers such as polystyrene particles and urea/formalin resin particles. They can be used in a suitably combined form.

In addition, paper making assistants such as a dye, a pH regulator, a slime controller, a defoaming agent and a thickener are suitably usable depending on the purpose.

In the paper making method of the present invention, pH is suitably selected in the range of about 4.5 (acidic paper making method) to about 6 to 8 (neutralized paper making method) as the occasion demands.

Th present molding base paper is made from a slurry comprising the above-described starting materials and chemicals by an ordinary method. The paper machine is not particularly limited, and an ordinary paper machine such as Fourdrinier machine, a cylinder paper machine, a tanmo machine, an inclined paper making machine or a paper machine of a suitable combination type is usable.

The sheet of paper can be dried with an ordinary multicylinder dryer, Yankee dryer or through dryer. The dryer is not particularly limited.

The molding base paper of the present invention may be comprised of a single layer or may be a multi-layer paper in a multi-layer structure comprising more than two layers. The multi-layer paper may be easily obtained by a multiple paper making method.

The molding base paper thus obtained has a basis weight in the range of preferably 100 to 500 g/m², more preferably 200 to 400 g/m². When the basis weight is below 100 g/m², the molded product obtained after the press molding cannot have a sufficient strength. On the contrary, when the basis weight is above 500 g/m², the moldability of the creased part is reduced unfavorably.

It is suitable that the density of the molding base paper is preferably 0.4 to 0.7g/cm³, more preferably 0.50 to 0.65 g/cm³.

The paper satisfying the conditions (1) to (4) of the present invention as stated above can be prepared by the above-described method. For well-balancing the strength, elongation, stiffness and compressibility, it is suitable that the molding base paper should be prepared by using a high density layer and a low density layer in combination.

The present molding base paper is desirably a multi-layer paper wherein a low density layer is used as an intermediate layer and high density layers are used as outer layers sandwiching the intermediate layer. By constructing the base paper this way, the resultant base paper becomes bulky and has a high stiffness. The low density layer and high density layer may be respectively constructed by two or more layers The density of the high density layer used in the molding base paper in a multi-paper form is suitably 0.7 to 0.9 g/cm³, preferably 0.75 to 0.85 g/cm³. The high density layer is preferably and mainly composed of kraft pulp or high-quality waste paper. By constructing the base paper this manner, the strength, elongation, stiffness and compressibility of the resultant base paper is well balanced.

The density of the low density layer used in the molding base paper in a multi-paper form is suitably less than 0.7g/cm³, preferably less than 0.2 to 0.6 g/cm³.

The stiffness of the sheet of paper, paper board or the like is represented as follows (supposing the sheet to be a cantilever):

S=E·I/B·W=E·T³/12·W

wherein E represents Young's modulus (MPa), I represents geometrical moment of inertia (N·cm²), B represents the width of sample (mm), W represents the weight of the sample (kg), and T represents the thickness of the sample (mm).

Namely, the stiffness S can be considered to be proportional to Young's modulus and the cube of the sheet thickness.

As for the stiffness of a sheet having a multi-layer structure like the paper board, A. T. Luey reported as follows in Tappi Nov. 1963, Vol. 46, No. 11: The value of the stiffness in each layer is determined from Young's modulus and geometrical moment of inertia of each layer. Then, the total of the values of the stiffness in the respective layers is calculated to determine the stiffness of the whole sheet. According to this idea, the stiffness becomes higher as the distance from the center of the paper thickness becomes longer or, in other words, as the paper is thickened. Therefore, the intermediate layer is desirably bulky. Because the stiffness is represented by (thickness)³ ×(Youngs modulus), the higher Young's modulus in the outer layer, the more effective in the improvement in the stiffness.

Therefore, it is suitable that the density of the intermediate layer is 0.2 to 0.6 g/cm³, preferably 0.3 to 0.5 g/cm³. When the density of the intermediate layer is below 0.2 g/cm³, the interlaminer strength is seriously lowered and, on the contrary, when it exceeds 0.6 g/cm³, the density of the whole base paper cannot be controlled at 0.4 to 0.7 g/cm³.

In the present invention, the density of the outer layer should be 0.7 to 0.9 g/cm³. When the density of the outer layer is below 0.7 g/cm³, the Young's modulus of the external layer is low and the improvement in the stiffness of the present invention cannot be expected. On the contrary, when the density exceeds 0.9 g/cm³, the surface of the outer layer of the base paper becomes excessively tense. Therefore, it is substantially difficult to obtain a layer having a higher density in the paper making step and, in addition, a suitable press moldability cannot be obtained.

Although the variety of the pulp used for forming the high density layer is not particularly limited, a pulp obtained by a high degree of beating of conifer tree pulp such as NUKP and NBKP to keep its stiffness is particularly desirable. For obtaining the effect of the present invention, the basis weight of the outer layer (a high density layer) is desirably 15 to 100 g/m². When the basis weight is less than 15 g/m², it may be difficult to obtain the layer having a high Young's modulus and also to make the paper itself. On the contrary, when the basis weight of the outer layer exceeds 100 g/m², the basis weight of the low-density layer is relatively reduced and, as a result, the density of the whole base paper is increased to make it difficult to control it in the range of 0.4 to 0.7 g/cm³.

In the present invention, the multi-layer base paper is produced with a multi-layer combination former like in the production of ordinary paper boards. For example, the pulp slurry in an amount corresponding to a dry basis weight of several ten g/m² is successively laminated on wire parts of about 10 stations to form a wet sheet.

Concretely, at first, about 40 g/m² of a pulp layer is formed on a wire part for forming a paper layer to be the outer layer. It is then dehydrated and moved on a blanket. Then, a paper layer to be the intermediate layer is also formed in another wire part repeatedly in the same manner as that described above. A necessary number of the intermediate layers are thus placed on the outer layer. Finally, another outer paper layer is formed to obtain the molding base paper of the present invention.

The pulp to be used in the present invention for forming the low density layer is that having a freeness of 200 to 650 ml, preferably 250 to 550 ml in a re-dissociated state according to Canadian standard of JIS-P 8121. When the freeness is below 200 ml, the pulp fibers cannot be efficiently dehydrated and, therefore, the squeezed sheet will have a dense structure. This fact makes the production of a paper layer structure of a low density difficult. On the contrary, when the freeness is over 650 ml, the density of the sheet is excessively low and, therefore, the ply separation is caused in the pressing step in the paper making process to cause balloon-like swelling.

A stock having a freeness of 200 to 650 ml in the re-dissociated form can be adjusted to a freeness of Canadian standard of 250 to 700 ml irrespective of the pulp used as the starting material. The determination of the freeness of the pulp by re-dissociating the base paper is effective for determining necessary pulp properties from a product having excellent operation properties in a short time. It is more preferable that any of mechanical pulp, mercerized pulp and curled fibers is contained in an amount of 50% or higher based on the total pulp.

The pulp material used for forming the low density layer is mainly a pulp material capable of easily foaming a paper layer of a low density. Concretely, these pulps are mechanical pulps. The mechanical pulps are usually obtained by mechanically breaking woods, particularly coniferous woods and then dissociating them. GP, TMP, RGP, etc are usable. In them, TMP and RGP are preferred. In particular, pulps obtained from monterey pine, southern pine, Douglas fir or the like are preferred for obtaining a paper layer of a low density because their fibers are rigid and they are not easily deformed. In addition, when they are used, lowering in the density is only slight in the press-molding step. Non-wood materials such as kenaf, reed, bamboo and bagasse (crushed sugar cane from which sugar has been removed) are also usable. Pulps obtained by a partial chemical treatment such as pulps obtained by the mechanical crushing in the presence of a chemical and bleached pulps are also included in the mechanical pulps.

Further, pulp materials used for preparing a low density layer may contain having a density reduced by a chemical treatment such as mercerized pulp and curled fibers are also preferably used.

In the present invention, the above-described pulps are mainly used for forming the low-density layer. They can be used in the form of a suitable mixture with pulps prepared from ordinary woods and also chemical pulps prepared from various non-wood materials such as kenaf, reed, bamboo and bagasse.

It is effective to form an outermost layer (hereinafter referred to as “crack preventing layer”) of a paper sheet having an elongation at break (JIS-P 8113) of at least 5% (in respect of at least one direction of the MD and CD direction) on at least one surface of all of the above-described molded base papers for the purpose of preventing formation of cracks on the surface of the resultant vessel in the course of the deep drawing process.

Moldings produced by the deep drawing technique are more stretched than those produced by shallow drawing technique in the molding step. In particular, a paper layer which forms the outer side of the molding is stretched in an extent higher than a layer which form the inner side. Thus, the outer side should have a higher elongation at break. Preferably, the elongation at break of the outer layer is at least 6%, more preferably 7%or higher.

The pulps usable for forming the outermost layer are those described above. In the wood fiber pulps, those having long fibers obtained from conifers such as pine, larch, cedar, fir and Japanese cypress are suitable for improving the extensibility and strength of the paper sheets.

In non-wood fibers, paper mulberry, paper bush, kenaf, Manila hemp, sisal, cotton and cotton linters are preferred because they have long fibers and they are capable of improving the extensibility and strength of the paper sheet.

The chemicals usable for making papers are ordinary chemicals used for making the molding base paper of the present invention. They are suitably selected from among sizing agents, strength additives, yield improvers, mineral fillers, organic rigid fillers, dyes, pH regulators, slime controlling agents, defoaming agents and thickening agents.

A paper sheet for the crack preventing layer having a high elongation at break can be prepared from a slurry containing the above-described starting materials and chemicals by the following steps: an apparatus for press-rotating an endless, thick rubber belt through nip rolls is applied to a part of a dryer roll in a wet paper making machine. A wet paper is passed between the dryer and the belt. The paper is shrunk by shrinking the previously extended belt. This method is called Clupak method. In another method, a paper sheet is peeled from a press roll, cylinder dryer or Yankee dryer of a paper making machine or processing machine with a doctor to form wrinkles. This method is called “crepe method.” The crepe method can be conducted in various ways with various devices, such as doctor devices, depending on the position of the crapes. For example, in duo-stress method, the crepe is provided with a doctor in a press part of a paper machine and then the paper is extended lengthwise and breadthwise by passing it through grooved rolls in a middle part of the dryer.

The paper sheet for the crack preventing layer obtained in the above-described paper-making step is not only a monolayer sheet and it can also be a combination board having two or more layers in the present invention.

The basis weight of the paper sheet for forming the crack preventing layer is preferably in the range of 40 to 300 g/m², more preferably 50 to 150 g/m². When the basis weight of this paper sheet is below 40 g/m², the tensile strength of the sheet is insufficient and the sheet is easily broken in the molding step and, on the contrary, when it exceeds 300 g/m², the density of the molding base paper obtained by the lamination with this paper sheet as the crack preventing layer is increased to lower the moldability of the creased part of the molding unfavorably.

The paper sheet for forming the crack preventing layer, obtained by this method, can be laminated with the molding base paper by an adhesive. The lamination method is not particularly limited. The lamination can be conducted by a wet lamination method wherein an aqueous adhesive such as a synthetic resin emulsion, starch or PVA is applied to the base paper and then the crack preventing layer is pressed on the base paper through nip rolls; a hot melt lamination method wherein a hot melt adhesive molten by heating is applied to the base paper and then the crack preventing layer is pressed on the base paper through nip rolls; or an extrusion lamination method wherein a thermoplastic resin such as polyethylene or polypropylene molten by heating is spread in the form of a film on the base paper and then the crack preventing layer is pressed on the base paper through nip rolls.

If necessary, a pigment coating layer comprising a pigment and an adhesive can be formed on one or both surfaces of the molding base paper of the present invention. By forming the coating layer, a high printability can be imparted to the surface of the molding base paper.

Further, a printed layer can be formed by using an ink such as dye ink or a pigment ink with an ordinary printing machine.

The pigment used for forming the coating layer can be suitably selected from known pigments such as calcium carbonate, kaolin, clay, talc, titanium oxide and plastic pigments.

The adhesives used for forming the coating layer can be suitably selected from known adhesives such as starch, casein, SBR latex and polyvinyl alcohol.

The coating layer may be either a singly layer or multiple layers. The amount of the coating is desirably about 20 to 30 g/m² in total.

When such a coating layer is to be formed, the layer directly under the coating layer preferably has an increased freeness and smoothened surface.

The coating layer can be formed with a coating apparatus suitably selected from various known apparatuses. It is also possible to further form a printing layer on the coating layer.

If necessary, a water-resistant film can be formed on one or both surfaces of the molding base paper of the present invention for the purpose of keeping the paper from impregnation with a liquid or leak. The water-resistant film can be formed directly on the base paper or on the coating layer or printing layer as desired.

The water-resistant film can be formed by coating a water-resistant coating or by laminating a synthetic resin. The method for the formation of the water-resistant film can be suitably selected according to the conditions.

The coatings to be applied to the surface of the base paper to make it water resistant include emulsions such as microcrystalline waxes and paraffin waxes; latices such as SBR latex and polyvinylidene chloride latex; and synthetic resin emulsions such as acrylic resin emulsions, self-emulsifiable polyolefin emulsions and polyethylene copolymer resin emulsions. The apparatus for applying the water-resistant coatings is not particularly limited, and it is suitably selected from among ordinary bar coater, air-knife coater, roll coater, blade coater, gate roll and size press. The coating amount of the coating after drying is preferably about 1.0 to 20.0 g/m² in total. The coating layer may be either monolayered or multilayered.

The synthetic resin layer to be formed on the surface of the base paper may be made of polyolefin resins such as polyethylene, polypropylene and polymethylpentene; saturated polyester resins such as polyethylene terephthalate and polybutylene terephthalate; polyamide resins such as nylon; ethylene/vinyl alcohol copolymer; polystyrene resin; and polyacrylonitrile resin. The base paper is laminated or coated with one of these synthetic resins or a mixture of two or more of them to form a water-resistant film. The method for the lamination of the synthetic resin layer is not particularly limited, and it is usually selected from among wet lamination, hot melt lamination, extrusion lamination, dry lamination and thermal lamination methods.

When the drawing is conducted by pressing under a very high pressure, non-uniformity in color is caused along the score line parts, in which the folding creases are formed, of the molding base paper which will be the surface of the vessel. The color non-uniformity seriously damages the appearance of the product to reduce the commercial value thereof.

It is effective for solving this problem by incorporating a pigment into the synthetic resin layer.

The amount of the pigment in the synthetic layer is preferably in the range of 3 to 40% by weight. When it is below 30% by weight, a sufficient effect of concealing the color non-uniformity would not be obtained. On the contrary, when it is larger than 40% by weight, the physical and chemical stability of the synthetic resin is lowered to make it difficult to form a stable synthetic resin layer on the base paper.

In particular, neck-in of the molten film occurs in T-die, and the synthetic resin layer partially lacks because of insufficiency in spreadability of the synthetic resin layer.

When the synthetic resin used is a polyolefinic resin and the pigment is titanium oxide, the amount of titanium oxide is preferably 5 to 10% by weight and the basis weight is preferably 15 to 60 g/m².

The water-resistant coatings or synthetic resins described above may be biodegradable thermoplastic resins.

The biodegradable thermoplastic resins are not particularly limited so far as they have a biodegradability equal to that of paper or higher. They include aliphatic polyesters such as 3-hydroxybutyrate/3-hydroxyvalerate copolymer, 3-hydroxybutyrate polymer and polycaprolactone; polyglycolides such as polylactic acid; polyvinyl alcohol; polyvinyl alcohol/starch composite; and cellulose derivatives such as cellulose acetate. Synthetic and/or natural resins can be used either alone or in the form of a mixture of them.

In those biodegradable thermoplastic resins, those particularly preferred in the present invention are aliphatic polyesters. The biodegradable aliphatic polyesters are excellent in the processability when they are to be laminated with the base paper and also in water resistance of the obtained product.

Biodegradable or non-biodegradable resins and additives may be added to these thermoplastic resins in order to improve the processability and physical properties of them. When the non-biodegradable resins and additives are added, the amount of them is desirably not heavier than the thermoplastic resins. When the former is heavier than the latter, a bad influence would be exerted on the biodegradability of the tray or vessel itself.

Then, the description will be made on the press molding of the molding base paper.

<Molding method>

Control of Water Content of Base Paper

The molded paper vessels of the present invention are produced by so-called drawing method wherein the blank sheets for vessels are stamped out of the base paper, the sheets are scored with lines at necessitated parts, and each of the blank sheets is placed between male and female molds of a press and pressed under heating. In this process, the water content of the molding base paper should be previously controlled.

Water content of the base paper should be in the range of 10 to 20%, preferably 11 to 17% and most preferably 12 to 15%. The term “water content of the base paper” herein indicates weight % of water based on the oven dry weight of the whole pulp in the molding base paper.

When the water content of the base paper is kept in this preferred range, the paper is plasticized to improve the moldability thereof and also to reduce the breaking of the paper layer in the course of the molding. As a result, the vessel obtained by the drawing has an increased deepness, smooth and beautiful appearance and a high stiffness.

When the water content of the base paper is below 10%, the molding having a sufficient stiffness cannot be obtained. On the other hand, when it exceeds 20%, the molding base paper is blistered and the layers of the base paper are peeled off and, in addition, a long time is necessitated for drying because the water content is high and, as a result, the productivity is lowered unfavorably.

The water content of the base paper can be controlled by a method wherein water is supplied to the base paper immediately before the press molding, or a method wherein the paper is moistened after it is delivered from a dryer in the paper making process and the paper is transported and stored while its water content is kept.

Molding Method

Description will be made on the step of producing the molded vessel from the blank sheet made of the molding base sheet of the present invention.

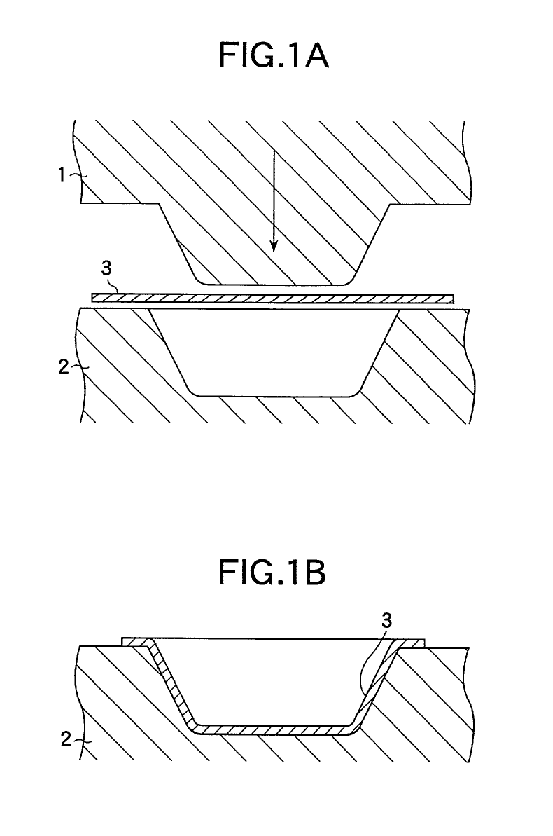

According to the present invention, the drawing is conducted with a pair of press molds. As shown in FIG. 1, a pair of press molds are a male mold (convex mold) 1, which is a concave form and has a shape corresponding to the inner surface of the molding to be obtained and a female mold (concave mold) 2 which is a convex form and has a shape corresponding to the outer surface of the molding. In FIG. 1, the convex mold 1 moves toward the concave mold 2 downwardly, to press the blank sheet 3. In this case, the direction in movement of the molds including a relative movement of the molds is not limited and is readily obvious to a person skilled in the art. For convenience for illustration, the convex mold is referred to as a upper mold and a concave mold is referred to as a lower mold and the description will be made with reference to the case where the upper mold moves toward the lower mold to press the blank sheet.

The blank sheet 3 can be heated by, for example, high frequency heating method, hot air heating method, infrared heating method or the like. The whole mold may be previously heated. In this case, a means of heating the mold is necessitated. In an ordinary heating means, the press mold is heated with an electric heating device. In another method, the press mold is connected with a high-frequency generator to heat the base sheet with the high frequency heating. A combination of the electric heating with the high frequency heating is also possible.

The heating temperature in the molding step is such that the temperature of the heated molding base paper is in the range of preferably 100 to 150° C., more preferably 110 to 140° C. When the temperature of the heated molding base paper is below 100° C., a long time is taken for the molding to lower the productivity and, on the contrary, when the temperature is higher than 150° C., the base paper is easily blistered particularly when it has a high water content.

The molding base paper can be controlled at the above-described, predetermined temperature by setting it in the heated pressing machine. In another method, the molding base paper containing water is heated with electromagnetic waves such as microwaves and then placed in the pressing machine.

The vessel molded from the blank sheet is taken out of the mold. Although the vessel taken out of the mold may be air-dried, the high-temperature vessel is preferably kept in a cooling mold for a predetermined time to cool it.

The heat pressing mold is made of a well-known material such as aluminum, an aluminum alloy, brass, iron, stainless steel or ceramic.

The mold can be operated by means of any of hydraulic press, air cylinder and cam mechanism. The clearance between the upper mold and the lower mold can be controlled by hydraulic or air pressure method. The pressure can be controlled by a computer depending on the thickness of the molding, or by adjusting the position of a stopper. In the cam mechanism, the clearance can be controlled depending on the previously designed shape of the cam and the descending speed of the mold.

In the press molding, the pressure is preferably in the range of 10 to 100 kgf/cm². When it is smaller than 10 kgf/cm², the compression deformation in the scored part is insufficient and, on the contrary, when it exceeds 100 kgf/cm², the paper layer is broken at the folding creased portions unfavorably.

The pressing time in the press molding step is preferably in the range of 2 to 30 seconds from the viewpoints of the moldability and workability.

<Shape of the Vessel>

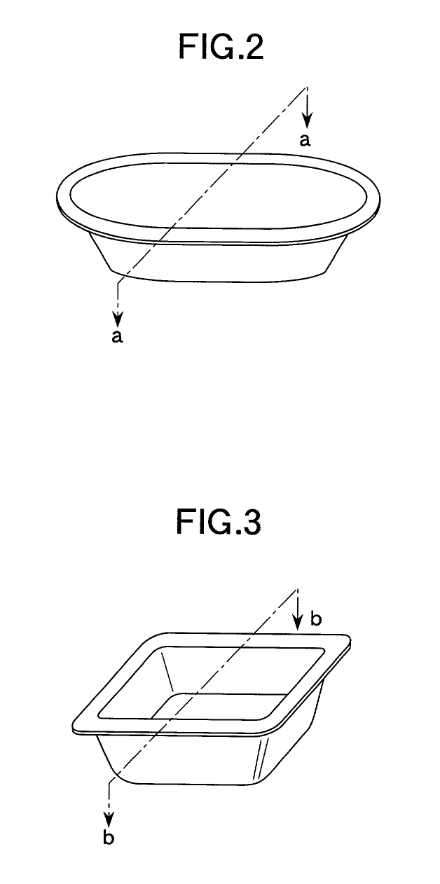

The vessel of the present invention is generally open at the upper edge and has a flange or rim at the upper edge thereof (FIGS. 2, 3 and 5). The flange may be curled.

The plan view of the vessel may be square, rectangular, round, oval or the like. When it is rectangular, the corner is usually round.

FIGS. 2 and 3 show examples of the vessels of the present invention prepared by the drawing method. FIG. 2 shows a vessel in an oval form. FIG. 3 shows a vessel in a rectangular form.

The vessel has a bottom and a side wall extending upwardly from the bottom. The bottom is typically flat. In FIGS. 2 and 3, the side wall upstanding from the flat bottom is not perpendicular to the bottom but is inclined outwardly or, in other words, it is tapered. When the side wall is perpendicular to the bottom, the vessels cannot be piled up one by one.

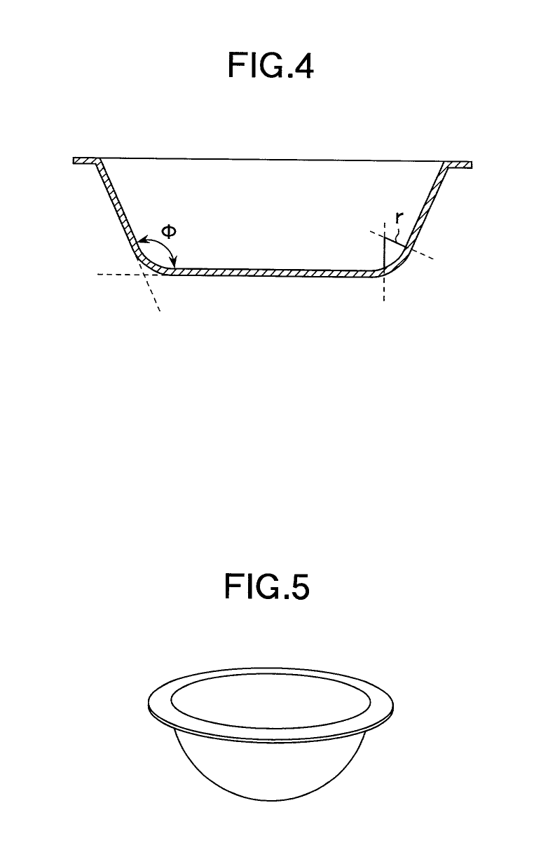

FIG. 4 is a cross-sectional view of the vessel taken along the a-a line in FIG. 2 or the b-b line in FIG. 3. In this case, the cross-sectional view is the same between the vessels shown in FIGS. 2 and 3.

In FIG. 4, a taper angle (φ) is the angle defined by the bottom and the side wall inside the vessel. The taper angle is preferably 95 to 130°. The radius of curvature at the corner of the vessel defined by the bottom and the side wall is indicated by (r) in FIG. 4.

In the paper vessel of the present invention, the corner between the bottom and the side wall is not folded but curved. When the radius of curvature is small, the paper is easily broken at the corner, particularly at the four angular corners and, in addition, wrinkles at the corner between the side walls are easily increased.

When the radius of curvature is large, a deep vessel cannot be obtained by the drawing and, the efficiency of the use of the material is low. When the area of the flat bottom is, for example, 10 cm×10 cm, the radius of curvature is preferably about 0.5 to 2 cm. The radius of curvature should be exactly determined according to the area of the bottom. When the value determined by dividing the radius of curvature (r) by the square root of the bottom area (S1) is 0.05 to 0.2, a deep vessel free from the breakage of the paper can be obtained by the drawing.

In the present invention, vessels not having the flat bottom can be obtained in addition to the above-described vessels having the roughly flat bottom and roughly flat sidewall. For example, as shown in FIG. 5, a semispherical vessel can be produced. A part of the bottom of the vessel as shown in FIG. 5 can be turned over inside the vessel with another pressing machine after the molding, so that the placing of the vessel can be stabilized.

<Area of the Bottom>

The area of the bottom (S1) is the area of a part of the vessel which part is brought into contact with a flat surface when the vessel is placed on the flat surface. When the area of the bottom is not easily determined, either projection bottom area S3 or virtual bottom area S4 as explained by the following methods (A) and (B) can be employed.

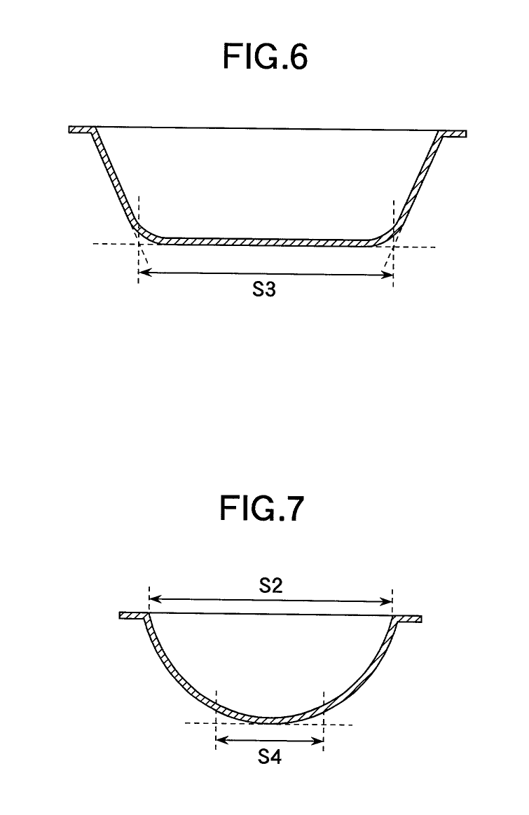

(A) When the sidewall is almost flat, the projection bottom area is the area of a part surrounded by a line drawn by the intersection of a line of a sidewall ridge rectangular to the edge and a line extending from the flat surface of the bottom. The projection bottom area S3 is shown in FIG. 6. FIG. 6 is a cross-sectional view similar to FIG. 4.

(B) The internal cubic volume V of the vessel is determined. The open area S2 at the top of the vessel is determined. The virtual bottom area S4 was determined according to the formula: V=(S4+S2)×H/2.

In this case, S2 is the area surrounded by the peripheral edge of the open side of the vessel as shown in FIG. 7, which is a cross-sectional view like FIG. 4.

<Height of Vessel>

The paper vessel obtained by the drawing is relatively deep in the present invention. The depth (height of the vessel) should be decided depending on the area of the bottom of the vessel.

Namely, the paper vessel obtained by the drawing in the present invention is characterized by satisfying the following formula (1):

0.2≦H/(S1)^{½} (1)

wherein S1 represents the bottom area of the vessel and H represents the height thereof.

S1 is as described above. If necessary, the value of S3 or S4 described above can be employed as the bottom area S1.

The value obtained by dividing the height H by the square root of the bottom area S1 according to formula (1) is preferably 0.3 to 1.2. Particularly when it is 0.4 or above, the vessel can be in the form of a cup.

When the value is below 0.2, it is suggested that a sufficient drawing could not be attained. The obtained vessel is unsuitable for receiving materials having a high water content or for liquids. In addition, in such a case, the effect of the side wall for increasing the stiffness of the vessel is insufficient.

When the value is larger than 1.2, the vessel obtained by the deep drawing is too deep to keep the base paper from being broken in the molding step.

When the vessel does not have the substantially plane bottom, it is preferable that the following formula (2) should be satisfied in the relationship between the height H and the opening area S2:

0.15≦H/(S 2)^{½} (2)

The shape of the vessel is the same as that in FIG. 5. S2 in FIG. 5 is the same as that in FIG. 7.

<Walls of Molded Vessels>

For obtaining the vessel having the above-described shape and a practically necessitated stiffness while the breakage in the curved area thereof is prevented, a molding base paper having a low density and a high strength must be used as a material for vessel wall to be formed by the drawing. For obtaining such a base paper, mechanical pulp containing a large amount of lignin remaining therein is preferred. The amount of the mechanical pulp in the whole paper can be determined by determining Kappa number according to JIS P-8211.

Namely, Kappa number of the whole pulp used for forming the vessel of the present invention is preferably 40 to 160.

The molding base paper of the present invention contains natural pulp as the main component, and its moldability is superior to that of conventional molding base papers.

The following Examples will further illustrate the present invention, which by no means limit the scope of the present invention. Unless otherwise stated, parts are given by weight of the solid.

### <EXAMPLE 1-1>

With a disc refiner, commercially available NBKP was beaten to 550 mlcsf (Tappi T-227, Canadian standard), monterey pine TMP was beaten to 300 mlcsf and commercially available NUKP was beaten to 550 mlcsf.

From these stocks, a paper board composed of three layers, i.e. the first layer of 40 g/m² NBKP, the second layer of 250 g/m² TMP and the third layer of 40 g/m² NUKP, was prepared with a multi-layer combination paper machine. The paper board was used as the molding paper base.

The tensile strength, elongation at break, critical compression stress and compression deformation in thickness direction of the base paper were determined by methods described below.

The base paper thus obtained was used to form a tray, and the moldability thereof was evaluated.

### <EXAMPLE 1-2>

A stock composed of 80 parts of commercial LBKP beaten to 500 mlcsf with a disc refiner, 20 parts of commercial NBKP beaten to 500 mlcsf and 10 parts of foaming microcapsules (trade name: Matsumoto Microsphere F-30D; a product of Matsumoto Yushi Seiyaku Co., Ltd.) was prepared.

A sheet of paper having a basis weight of 150 g/m² was made from the stock with an experimental machine for making hand-made paper, and then dried with a rotary drier at 110° C. The hand-made paper was used as the molding base paper and evaluated in the same manner as that of Example 1-1.

### <EXAMPLE 1-3>

Commercial NBKP was beaten to 600 mlcsf with a disc refiner to obtain a stock. A sheet of paper having a basis weight of 260 g/m² was made from the stock with an experimental machine for making hand-made paper, and then dried with a rotary drier at 110° C. The hand-made paper was used as the molding base paper and evaluated in the same manner as that of Example 1-1.

### <EXAMPLE 1-4>

Monterey pine TMP was beaten to 300 mlcsf with a disc refiner to obtain a stock. A sheet of paper having a basis weight of 280 g/m² was made from the stock with an experimental machine for making hand-made paper, and then dried with a rotary drier at 110° C. The hand-made paper was used as the molding base paper and evaluated in the same manner as that of Example 1-1.

### <COMPARATIVE EXAMPLE 1-1>

50 parts by weight of curled fiber (a product of Weyerhaeuser Co.) and 50 parts by weight of monterey pine TMP were dissociated and mixed together without beating to obtain a stock. A sheet of paper having a basis weight of 290 g/m² was made from the stock with an experimental machine for making hand-made paper. The paper was used as the molding base paper and evaluated in the same manner as that of Example 1-1.

### <COMPARATIVE EXAMPLE 1-2>

The evaluation was conducted in the same manner as that of Example 1-1 except that the molding base paper was replaced with a production filter paper (trade name: Standard Filter Paper No. 2; a product of Advantech Toyo (KK); basis weight: 125 g/m²).

### <COMPARATIVE EXAMPLE 1-3>

The evaluation was conducted in the same manner as that of Example 1-1 except that the molding base paper was replaced with K liner (trade name: NRK 280; a product of Oji Paper Co., Ltd.; basis weight: 280 g/m²).

### <COMPARATIVE EXAMPLE 1-4>

The evaluation was conducted in the same manner as that of Example 1-1 except that the molding base paper was replaced with a base paper for cups (a product of Shin-Fuji Seishi (KK); basis weight: 290 g/m²).

(Evaluation Methods)

(1) Tensile Strength

Test pieces obtained by cutting a test paper to a width of 15 mm and length of 250 mm respectively in the flow direction and the cross direction were kept under conditions of 23° C. and 50% RH for at least 24 hours to control the moisture thereof. Then, the tensile strength of the test pieces was determined with Strograph M2 tester (a product of Toyo Seiki Seisaku-sho, Ltd.) at a rate of pulling of 20 mm/min according to JIS-P 8113.

(2) Elongation at Break

Test pieces obtained by cutting a test paper to a width of 15 mm and length of 250 mm respectively in the flow direction and the cross direction were kept under conditions of 23° C. and 50% RH for at least 24 hours to control the moisture thereof. Then, the elongation at break of the test pieces was determined with Strograph M2 tester (a product of Toyo Seiki Seisaku-sho, Ltd.) at a rate of pulling of 20 mm/min according to JIS-P 8113.

(3) Critical Compression Stress

Test pieces obtained by cutting a test paper to a width of 12.7 mm and length of 152.4 mm respectively in the flow direction and the cross direction were kept under conditions of 23° C. and 50% RH for at least 24 hours to control the moisture thereof. Then, the compression strength A of the test pieces was determined with digital ring crush tester X-1104 (a product of (KK) Orientech) according to JIS-P 8126. Further, the area B of the loaded part of the test piece in the step of determining compression strength was determined. The critical compression stress was calculated according to the following formula:

Critical compression stress=A/B

wherein the unit of critical compression stress is MPa, unit of compression strength is N, and the area of the loaded part of the test piece is calculated by the formula:

(thickness of test piece)(mm)×152.4 mm

wherein the thickness of the test piece was determined according to JIS-P 8118 by using a sample having a moisture controlled under conditions of 23° C. and 50% RH for at least 24 hours.

(4) Compression Deformation:

The moisture of 50 mm×50 mm test pieces was controlled under conditions of 23° C. and 50% RH for at least 24 hours. Each test piece was pressed in the thickness direction with Strograph M2 tester (a product of Toyo Seiki Seisaku-sho, Ltd.) at a compression rate of 1.0 mm/min to draw a stress-distortion curve to determine the compression (distortion) under a compression stress of 20 kgf/cm².

(5) Moldability

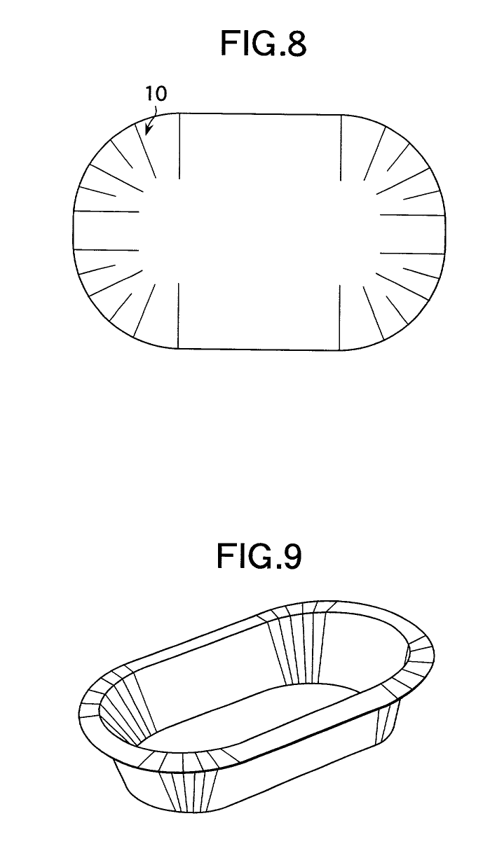

A molding base paper was scored with 24 lines to form a molding blank sheet as shown in FIG. 8. The blank sheet was molded into a tray with the molds and a press molding machine under conditions comprising a press pressure of 35 kgf/cm², press temperature of 150° C. and press time of 5 seconds to form a tray (having a major axis of about 20 cm, a minor axis of about 14 cm and a height of about 4 cm) as shown in FIG. 9.

The moldability was evaluated according to the following three criteria:

∘: The sheet could be molded in a tray shape and the obtained product had the smooth surface.

Δ: Although the sheet could be molded in the tray shape, the obtained product had the rough surface particularly in the folding creased part. [symbol] The blank was broken in the molding step to make the molding in the tray shape impossible.

The results of the evaluation are shown in Tables 1 and 2.

TABLE 1

| | | Basis weight |
|---|---|---|
| | Molding base paper | (g/m²) |
| Example 1-1 | NBKP/TMP/NUKP | 336 |
| Example 1-2 | LBKP + NBKP + foaming agent | 156 |
| Example 1-3 | NBKP hand-made paper | 255 |
| Example 1-4 | TMP hand-made paper | 282 |
| Comp. | Curled fiber/TMP | 290 |
| Ex. 1-1 | | |
| Comp. | No. 2 filter paper | 132 |
| Ex. 1-2 | | |
| Comp. | NRK 280 | 274 |
| Ex. 1-3 | | |
| Comp. | Base paper for cups | 289 |
| Ex. 1-4 | | |

| | Thickness | | Basis weight of | Density of |
|---|---|---|---|---|
| | (mm) | Density | each layer | each layer |
| Example 1-1 | 0.642 | 0.52 | NBKP | 0.70 |
| | | | TMP | 0.48 |
| | | | NUKP | 0.70 |
| Example 1-2 | 0.997 | 0.16 | | |
| Example 1-3 | 0.493 | 0.52 | | |
| Example 1-4 | 0.970 | 0.29 | | |
| Comp. Ex. 1-1 | 1.040 | 0.28 | | |
| Comp. Ex. 1-2 | 0.281 | 0.47 | | |
| Comp. Ex. 1-3 | 0.335 | 0.82 | | |
| Comp. Ex. 1-4 | 0.327 | 0.88 | | |

TABLE 2

| | Tensile | | Elongation | | Critical | | Compres- | |
|---|---|---|---|---|---|---|---|---|
| | strength | | at break | | compression | | sion | |
| | (kN/m) | | (%) | | stress (MPa) | | deforma- | Molda- |
| | MD | CD | MD | CD | MD | CD | tion (%) | bility |
| Example 1-1 | 19.7 | 9.4 | 2.4 | 5.7 | 7.8 | 5.7 | 17 | ◯ |
| Example 1-2 | 2.4 | | 2.8 | | 1.1 | | 74 | ◯ |
| Example 1-3 | 7.3 | | 4.4 | | 3.5 | | 11 | ◯ |
| Example 1-4 | 6.4 | | 2.7 | | 1.7 | | 20 | ◯ |
| Comp. Ex. | 6.2 | 3.4 | 1.4 | 3.0 | 1.9 | 1.4 | 36 | X |
| 1-1 | | | | | | | | |
| Comp. Ex. | 3.4 | 1.7 | 1.4 | 3.3 | 3.7 | 2.6 | 22 | X |
| 1-2 | | | | | | | | |
| Comp. Ex. | 16.8 | 7.3 | 2.4 | 6.5 | 14.8 | 11.0 | 10 | Δ |
| 1-3 | | | | | | | | |
| Comp. Ex, 4 | 23.1 | 9.9 | 2.6 | 8.3 | 15.8 | 11.6 | 8.4 | Δ |

It is clear from Tables 1 and 2 that the molding base paper sheets of the present invention have excellent moldability because they are not cracked and the folding creased parts thereof do not become uneven in the molding step.

### <EXAMPLE 2-1>

The following three kinds of pulps (1) to (3) were combined together in the following order at a wire speed of 300 m/min with an experimental orientation paper machine of Kumagai Riki Kogyo to make a combined paper.

(1) Commercial NBKP having 450 mlcsf, 50 g/m²

(2) Monterey pine TMP having 350 mlcsf, 180 g/m²

(3) Commercial NBKP having 450 mlcsf, 50 g/m²

(These stocks were beaten to a predetermined freeness with KRK high-concentration disc refiner-type beater of Kumagai Riki Kogyo)

In the lamination, a 2.0% aqueous dispersion of starch (ONL510: a product of Oji Corn Starch) was sprayed on the surface (felt side) of each layer in such an amount that 1.0 g/m² of the solid would be applied thereto. The layers were combined together to form a laminate.

The wet laminate sheet thus obtained was placed between monoplastic canvas sheets (product of Shikishima Canvas Co.) and pressed with a calender (product of Yuri Roll Machine) at a rate of 30 m/min under a nipping pressure of 10 kg/cm.

Then, the sheet was dried with a ferrotype cylindrical heating dryer.

The moisture of the sheet was controlled under conditions of 20° C. and 65% RH and treated with a calender (product of Yuri Roru Kikai) at a rate of 20 m/min under a nipping pressure of 20 kg/cm. 8.0% PVA (Kuraray POVAL PVA-KL 118; a product of Kuraray Co., Ltd.) was applied to the sheet by hand in an coating amount of 2.0 g/m². Then, the sheet was treated with a calender (product of Yuri Roll Machine) at 120° C. at a rate of 20 m/min under a nipping pressure of 40 kg/cm to obtain the molding base paper.

The moisture of the molding base paper was controlled under conditions of 20° C. and 65% RH, and then the basis weight, thickness, density and Z strength Taber stiffness thereof were determined.

Further, a polypropylene film having a thickness of 40 μm was laminated on the surface of the molding base paper by melt extrusion to obtain a sheet for producing a molded paper vessel.

An oval-shaped blank sheet was stamped out of the sheet. The blank sheet was radially provided with score lines 10 at both sides as shown in FIG. 8.

The blank sheet thus obtained was heat-pressed between a pair of upper and lower molds for forming an oval-shaped tray with a test press molding machine (a product of Dai-Ichi Koki) at 130° C. under 35 kg/cm² to obtain paper vessels having a major axis of about 20 cm, a minor axis of about 14 cm and a height of about 4 cm (see FIG. 9).

A gelatinized liquid obtained by gelatinizing 7% starch (Oji Ace A; a product of Oji Corn Starch Co.) in water at 70° C. was cooled to ambient temperature was used in place of a food. 250 g of the gelatinized liquid was fed into the molded paper vessel. After confirming that the molded paper vessel containing the gelatinized liquid was apparently free from swelling in the body and the bottom and that the shape of the vessel was normal, the open edge of the vessel was covered with a polyethylene film and placed in a refrigerator. After leaving the vessel to stand at 5° C. for 12 hours, the extents of the swelling in the body and bottom of the molded paper vessel were judged by a method described below.

### <EXAMPLE 2-2>

A combined paper was made in the same manner as that of Example 2-1 except that three kinds of pulps shown below were used, that a coating liquid shown below was applied to the surface with Mayer bar by hand so that 9.0 g/m² of an undercoating and 10.0 g/m² of a topcoating were formed after drying, and that the laminated paper was dried at 105° C. in a hot air dryer (a product of Advantech KK) for 60 seconds.

(1) Commercial NBKP having 450 mlcsf, 50 g/m²

(2) Monterey pine TMP having 300 mlcsf/commercial NBKP having, 150 mlcsf (70/30), freeness after the combination: 280 mlcsf, 230 g/m²

(3) Commercial NBKP having 450 mlcsf, 50 g/m²

[Coating Composition]

Topcoating: Kaolin (Ultrawhite 90;Engelheart Co.)/calcium carbonate (Brilliant 15; Shiraishi Kogyo)/titanium oxide (TCA 333;Tokemu Product)=50/35/15 and latex (L1410; Asahi Chemical Industry Co., Ltd.)/urea starch phosphate (MS 4600; Nihon Shokuhin Kako Co., Ltd.)=15/5 (parts by weight of the solid; the same shall apply hereinafter).

Undercoating: Kaolin (Kaobright; Thiele Co.)/calcium carbonate (Softon 2200; Bihoku-Funka)=50/50 and latex (0668: JSR)/urea starch phosphate (MS 4600; Nihon Shokuhin Kako Co., Ltd.)=15/5.

The molding base paper and then the molded paper vessel were produced in the same manner as that of Example 2-1. The determination and evaluation were conducted in the same manner as that described above.

### <EXAMPLE 2-3>

A combined paper was made in the same manner as that of Example 1 except that three kinds of pulps shown below were used:

(1) Commercial NBKP having 450 mlcsf, 50 g/m²

(2) Commercial mercerized pulp having 300 mlcsf/commercial NBKP having 150 mlcsf (70/30), freeness after the combination: 250 mlcsf, 200 g/m²

(3) Commercial NBKP having 450 mlcsf, 50 g/m²

The molding base paper and then the molded paper vessel were produced in the same manner as that of Example 2-1. The determination and evaluation were conducted in the same manner as that described above.

### <EXAMPLE 2-4>

A combined paper was made in the same manner as that of Example 1 except that three kinds of pulps shown below were used:

(1) Commercial NBKP having 450 mlcsf, 50 g/m²

(2) Commercial NBKP having 150 mlcsf/curled fibers (Weyerhauser) having 750 mlcsf (70/30), freeness after the combination: 300 mlcsf, 160 g/m²

(3) commercial NBKP having 450 mlcsf, 40 g/m²

The molding base paper and then the molded paper vessel were produced in the same manner as that of Example 2-1. The determination and evaluation were conducted in the same manner as that described above.

### <EXAMPLE 2-5>

A combined paper was made in the same manner as that of Example 2-1 except that three kinds of pulps shown below were used:

(1) Commercial NBKP having 450 mlcsf, 50 g/m²

(2) Kenaf TMP having 350 mlcsf, 185 g/m²

(3) Commercial NBKP having 380 mlcsf, 50 g/m²

The molding base paper and then the molded paper vessel were produced in the same manner as that of Example 2-1. The determination and evaluation were conducted in the same manner as that described above.

### <REFERENCE EXAMPLE 2-1>

A paper was made in the same manner as that of Example 2-1 except that only one kind of pulp shown below was used to form only one layer:

(1) Commercial NBKP having 450 mlcsf, 350 g/m²

The molding base paper and then the molded paper vessel were produced in the same manner as that of Example 2-1. The determination and evaluation were conducted in the same manner as that described above.

### <REFERENCE EXAMPLE 2-2>

A paper was made in the same manner as that of Example 2-1 except that two kinds of pulps shown below were used to form 2 layers:

(1) Commercial NBKP having 450 mlcsf, 50 g/m²

(2) Monterey pine TMP having 350 mlcsf, 250 g/m²

The molding base paper and then the molded paper vessel were produced in the same manner as that of Example 2-1. The determination and evaluation were conducted in the same manner as that described above.

### <REFERENCE EXAMPLE 2-3>

A paper was made in the same manner as that of Example 1 except that only one kind of pulp shown below was used to form only one layer:

(1) Commercial NBKP having 450 mlcsf, 360 g/m²

The molding base paper and then the molded paper vessel were produced in the same manner as that of Example 2-1. The determination and evaluation were conducted in the same manner as that described above.

The results of the determination and evaluation obtained in above Examples and Comparative Examples are shown in Tables 3 and 4.

The evaluation methods were as follows:

[Density of each paper layer]

The layers were separated from each other by an interlaminar peeling method stated in interlaminar peeling strength test of combined paper board according to JIS P 8139, and thickness (mm) and basis weight (g/m²) of each of them were determined.

Because each of the peeled layers was fluffy and thicker than the actual thickness due to the fluff, a correction factor was calculated according to the following formula to correct the thickness of each peeled layer, and the density of the layer was calculated:

Correction factor=(the whole layer thickness before peeling)/(total thickness of the layers after peeling)

When the peeling of the layers by the interlaminar peeling method stated in interlaminar peeling strength test of laminated paper board according to JIS P 8139 was difficult, the combined sheet sample was immersed in 60° C. water for 1 hour and then the sample was divided into the surface layer, intermediate layer and back layer by peeling. The respective layers thus obtained were dried and the thickness (mm) and basis weight (g/m²) of each of them were determined. Then, the correction factor was calculated as described above, and the thickness of each layer was corrected, and the density of the layer was calculated.

[Judgement of Body Swelling Rate]

The periphery of the middle of body of the paper tray was measured. The difference in the periphery measured in the normal state before the test and that measured 12 hours after was calculated and then the body welling rate was calculated.

Body swelling rate (%)=[(periphery of middle of the body 12 hours after)−(periphery of middle of the body before evaluation test)]/(periphery of middle of the body before evaluation test)

The body swelling rate higher than 3.0% was judged to be [symbol] [symbol] that in the range of 1.5 to 3.0% was judged to be [symbol] and that below 1.5% was judged to be ∘.

TABLE 3

| Example | Molding | | Pulp | Total basis |
|---|---|---|---|---|
| No. | method | Layer | combination | weight (g/m²) |
| 2-1 | press | top | NBKP | 310 |
| | | intermediate | TMP | |
| | | back | NBKP | |
| 2-2 | press | top | NBKP | 330 |
| | | intermediate | N material | |
| | | | TMP + NBKP | |
| | | back | NBKP | |
| 2-3 | press | top | NBKP | 310 |
| | | intermediate | mercerized | |
| | | | pulp + NBKP | |
| | | back | NBKP | |
| 2-4 | press | top | NBKP | 260 |
| | | intermediate | NBKP + CF | |
| | | back | NBKP | |
| 2-5 | press | top | NBKP | 290 |
| | | intermediate | kenaf TMP | |
| | | back | NBKP | |

| | Basis | | | | |
|---|---|---|---|---|---|
| | weight of | Density of | Density of | Stiffness | |
| Example | each layer | whole layers | each layer | MD (g · | Body |
| No. | (g/m²) | (g/cm³) | (g/cm³) | cm) | swelling |
| 2-1 | 50 | 0.55 | 0.80 | 410 | ∘ |
| | 200 | | 0.50 | | |
| | 50 | | 0.80 | | |
| 2-2 | 50 | 0.60 | 0.80 | 375 | ∘ |
| | 200 | | 0.52 | | |
| | 50 | | 0.80 | | |
| 2-3 | 50 | 0.60 | 0.80 | 360 | ∘ |
| | 200 | | 0.52 | | |
| | 50 | | 0.80 | | |
| 2-4 | 50 | 0.55 | 0.80 | 285 | ∘ |
| | 160 | | 0.50 | | |
| | 40 | | 0.80 | | |
| 2-5 | 50 | 0.55 | 0.80 | 410 | ∘ |
| | 185 | | 0.50 | | |
| | 50 | | 0.80 | | |

Note: “N material” means a coniferous tree material.

TABLE 4

| | | | | Total basis |
|---|---|---|---|---|
| Reference | Molding | | Pulp | weight |
| Example No. | method | Layer | combination | (g/m²) |
| 2-1 | press | top | NBKP | 360 |
| | | intermediate | none | |
| | | back | none | |
| 2-2 | press | top | NBKP | 260 |
| | | intermediate | NBKP | |
| | | back | none | |
| 2-3 | press | top | NBKP | 370 |
| | | intermediate | none | |
| | | back | none | |

| | Basis | | | | |
|---|---|---|---|---|---|
| | weight of | | | | |
| | each | Density of | Density of | Stiffness | |
| Example | layer | whole layers | each layer | MD (g · | Body |
| No. | (g/m²) | (g/cm³) | (g/cm³) | cm) | swelling |
| 2-1 | 350 | 0.80 | 0.80 | 200 | x |
| | none | | none | | |
| | none | | none | | |
| 2-2 | 50 | 0.80 | 0.80 | 150 | x |
| | 200 | | 0.80 | | |
| | none | | none | | |
| 2-3 | 360 | 0.80 | 0.80 | 210 | x |
| | none | | none | | |
| | none | | none | | |

### <EXAMPLE 3-1>

The molding base paper obtained in the same manner as that of Example 2-1 was treated with water vapor to control the water content thereof at 12%. An oval-shaped blank sheet was stamped out of the base paper. The blank sheet was radially provided with score lines at both sides as shown in FIG. 8.

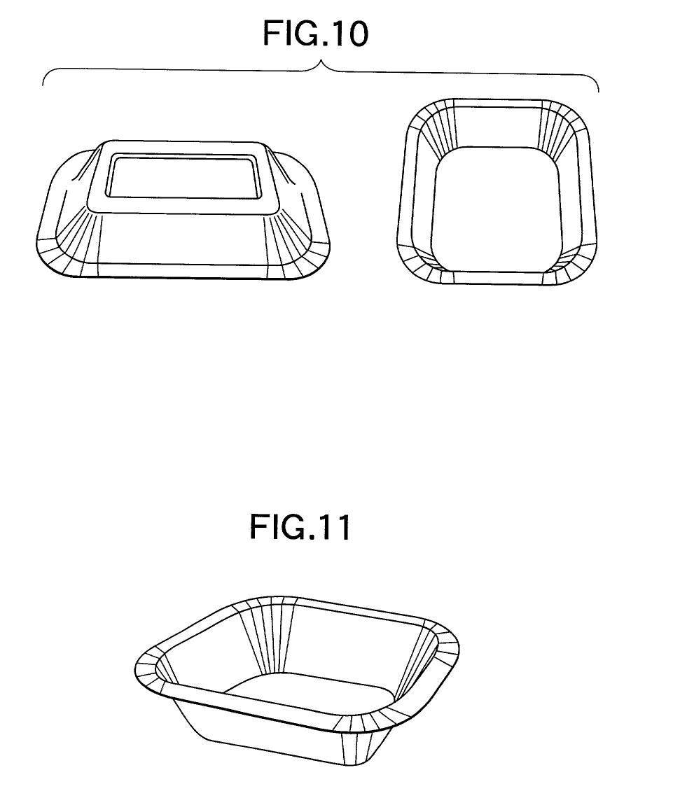

The blank sheet thus obtained was heat-pressed between a pair of upper and lower molds for forming a paper tray with a test press molding machine (a product of Dai-Ichi Koki) at 130° C. under 35 kg/cm² to obtain paper tray having a height of 4 cm and an opening of an almost rectangular shape having a length of 18.6 cm and a width of 12.6 cm as shown in FIG. 10. It also had a flange having a width of 0.7 cm. The tray vessel thus obtained by the drawing had a curved side wall and also a curved area between the side wall and the bottom.

The obtained tray had a taper angle (φ) of 115°, radius of curvature (r) of 2 cm and bottom area (S1) of 72 cm². Accordingly, H/(S1)^{½} was 0.47, r/(S1)^{½} was 0.24, and H/(S2)^{½} was 0.26.

The degree of swelling in the body of the tray obtained by the drawing was also determined as described below.

### <EXAMPLE 3-2>

A molding base paper was obtained in the same manner as that of Example 2-2.

A blank sheet was obtained in the same manner as that of Example 3-1 except that the shape of the blank sheet was roughly square, that the corners thereof were round, that a pair of upper and lower molds for forming a square vessel was used, that the water content of the blank sheet was 15% and that the molding temperature was 140° C.

Thus, almost square tray was obtained by the drawing as shown in FIG. 11. This tray had a height of 2.8 cm and an opening of an almost rectangular shape having a length of each side of the opening of 8 cm. It also had a flange or rim having a width of 1 cm, and a curved side wall and also a curved area between the side wall and the bottom.

The tray had a taper angle (φ) of 113°, radius of curvature (r) of 1.3 cm and bottom surface (S1) of 20 cm². Accordingly, H/(S1)^{½} was 0.62, r/(S1)^{½} was 0.29, and H/(S2)^{½} was 0.35.

The tray thus obtained by drawing was evaluated in the same manner as that of Example 3-1.

### <EXAMPLE 3-3>

A combined paper was made in the same manner as that of Example 3-1 except that three kinds of pulps shown below were used:

(1) Commercial NBKP having 450 mlcsf, 50 g/m²

(2) Monterey pine TMP having 350 mlcsf/commercial LBKP having 350 mlcsf (70/30), freeness after the combination: 350 mlcsf, 200 g/m²

(3) Commercial NBKP having 380 mlcsf, 50 g/m²

The molding base paper was produced in the same manner as that of Example 3-1. After controlling the moisture under conditions of 20° C. and 65%RH, the basis weight, thickness and density of the paper were determined.

The surface of the base paper (inner surface of the vessel) was laminated with a polypropylene film having a thickness of 40 μm in the same manner as that of Example 3-1 to obtain a blank sheer for forming a vessel.

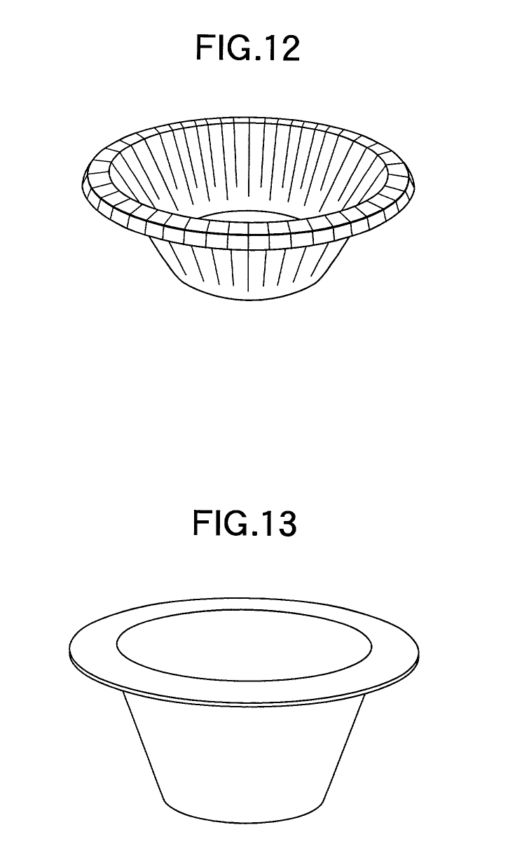

Then, the blank sheet was molded in the same manner as that of Example 1 except that the blank sheet was round, that the mold was bowl-shaped, that the water content of the blank sheet was 13% and that the molding temperature was 120° C. The bowl-shaped vessel thus obtained by the drawing had a height of 5.5 cm and an opening of a diameter of 12 cm as shown in FIG. 12. It also had a flange or rim having a width of 0.8 cm, and a curved side wall and also a curved area between the side wall and the bottom.

The vessel had a taper angle (φ) of 114°, radius of curvature (r) of 1 cm and bottom surface (S1) of 28 cm². Accordingly, H/(S1)^{½} was 1.03, r/(S1)^{½} was 0.19, and H/(S2)^{½} was 0.52.

The results of the evaluation in Examples 3-1 to 3-3 are shown in Table 5.

TABLE 5

| | | | Total basis |
|---|---|---|---|
| Example | | Pulp | weight |
| No. | Layer | combination | (g/m²) |
| 3-1 | top | NBKP | 310 |
| | intermediate | TMP | |
| | back | NBKP | |
| 3-2 | top | NBKP | 330 |
| | intermediate | N material | |
| | | TMP + | |
| | | NBKP | |
| | back | NBKP | |
| 3-3 | top | NBKP | 310 |
| | intermediate | N material | |
| | | TMP + | |
| | | LBKP | |
| | back | NBKP | |

| | Basis | | | | |
|---|---|---|---|---|---|
| | weight | Density of | Density | | |
| | of each | whole | of each | | Elongation |
| Example | layer | layers | layer | Body | at break |
| No. | (g/m²) | (g/cm³) | (g/cm³) | swelling | (MD/CD) (%) |
| 3-1 | 50 | 0.55 | 0.80 | ∘ | 3.4/6.9 |
| | 200 | | 0.50 | | |
| | 50 | | 0.80 | | |
| 3-2 | 50 | 0.60 | 0.80 | ∘ | 2.9/6.3 |
| | 200 | | 0.52 | | |
| | 50 | | 0.80 | | |
| 3-3 | 50 | 0.60 | 0.80 | ∘ | 2.4/5.2 |
| | 200 | | 0.52 | | |
| | 50 | | 0.72 | | |

### <EXAMPLE 4-1>

(Effect of Outer layer on Base Paper)

With a disc refiner, commercially available NBKP was beaten to 550 mlcsf (Tappi T-227, Canadian standard) and monterey pine TMP was beaten to 300 mlcsf. From these stocks, a paper support composed of two layers, i.e. the first layer of 40 g/m² NBKP and the second layer of 250 g/m² TMP, was prepared with a multi-layer combination paper machine. A bleached, stretching kraft paper (Oji Paper Co., Ltd., basis weight: 75 g/m²) was applied as an outer layer sheet to the paper support to obtain a molding base paper. The combination was conducted as follows: 20 g/m² (in terms of solid) of an EVA emulsion-type adhesive (trade name: Vinisol 1412 KAI; Daido Kasei) was applied to the TMP layer surface of the paper board with Mayer bar. Immediately thereafter, the bleached, stretching draft paper was pressed on the undried coating layer with a hand roll. After drying with a hot air dryer at 110° C. for 20 seconds, the molding base paper thus obtained was subjected to the tests described below to examine its elongation at break and moldability.

In this case, the multi-layer base paper without the outer layer has the following layer construction.

| | kind of | density | base weight |
|---|---|---|---|
| | pulp | (g/cm³) | (g/m²) |
| top layer | NBKP | 0.70 | 40 |
| back layer | TMP | 0.48 | 250 |
| Total layer | — | 0.50 | 290 |

### <EXAMPLE 4-2>

A molding base paper was prepared and evaluated in the same manner as that of Example 4-1 except that the outer layer sheet to be applied to the paper support was replaced with an unbleached stretching kraft paper for cement bags (Oji Paper Co., Ltd., basis weight: 83 g/m²).

### <EXAMPLE 4-3>

A molding base paper was prepared and evaluated in the same manner as that of Example 4-1 except that the second layer of the paper support contained 180 g/m² of TMP and the outer layer sheet to be applied to the paper support was replaced with a stretching kraft paper for adhesive tapes.

(Evaluation Methods)

(1) Elongation at Break

A blank sheet obtained by cutting the resultant test paper to a width of 15 mm and length of 250 mm respectively in both the flow direction and cross direction were kept under conditions of 23° C. and 50% RH for at least 24 hours to control the moisture thereof. Then, the elongation at break of the blank sheet was determined with Strograph M2 tester (a product of Toyo Seiki Seisaku-sho, Ltd.) at a rate of pulling of 20 mm/min according to JIS-P 8113.

(2) Moldability

The moisture of the sheet was controlled at 12% by the treatment with water vapor. Circular blank sheet was stamped out of the sheet. The blank sheet was radially scored with lines. The blank sheet thus obtained was heat-pressed between a pair of upper and lower molds for forming a cup-shaped tray with a test press molding machine (a product of Dai-Ichi Koki) at 130° C. under 35 kg/cm² to obtain a cup-shaped paper vessel having a height of 7 cm, a circular opening having a diameter of 12 cm and a circular bottom having a diameter of 6 cm. It also had a flange or rim having a width of 0.8 cm, and a curved side wall and also a curved area between the side wall and the bottom as shown in FIG. 13. The molding was conducted in such a manner that the outer layer side of the sheet formed was the outside of the vessel. The moldability was evaluated as follows:

∘: The sheet could be molded into cups, the outer layer of each molding was not broken and the molding surface was smooth.

Δ: The sheet could be molded into a cup but the outer layer of the cup was broken.

[symbol] X: The blank sheet was broken in the molding step and it could not be molded into a cup.

The evaluation results are shown in Table 6.

TABLE 6

| | | Example 4-1 | Example 4-2 | Example 4-3 |
|---|---|---|---|---|
| Outer | Kind | Bleached | Unbleached | Unbleached |
| layer | | stretching | stretching | stretching |
| sheet | | kraft paper | kraft paper for | kraft paper |
| | | | cement bag | for adhesive |
| | | | | tape |
| | Basis weight | 75 | 83 | 73 |
| | (g/m²) | | | |
| | Density | 0.72 | 0.60 | 0.68 |
| | (g/cm³) | | | |
| | Elongation at | | | |
| | break (%) | | | |
| | MD | 9.0 | 6.5 | 7.4 |
| | CD | 7.9 | 7.9 | 8.9 |
| Basis weight of base | | 292 | 292 | 225 |
| paper (g/m²) | | | | |
| Total base | Basis weight | 387 | 396 | 320 |
| paper | (g/m²) | | | |
| | Density | 0.56 | 0.54 | 0.60 |
| | (g/cm³) | | | |
| | Moldability | ∘ | ∘ | ∘ |

It is clear from Table 6 that the molding base paper of the present invention is excellent in moldability because when it is used even for deep molding to form a cup or the like, the outer paper layer surface is not cracked or broken in the molding step.

### <EXAMPLE 5-1>

A molding base paper was obtained in the same manner as that of

### EXAMPLE 2-1.

[Determination of Outer Layer Density]

The layers were separated from each other by an interlaminar peeling method stated in interlaminar peeling strength test of combined paper board according to JIS P 8139, and thickness (mm) and basis weight (g/m²) of each of them were determined.

Because each of the peeled layers was fluffy and thicker than the actual thickness due to the fluff, a correction factor was calculated according to the following formula to correct the thickness of each peeled layer, and the density of the layer was calculated:

Correction factor=(the whole layer thickness before peeling)/(total thickness of the layers after peeling)

When the peeling of the layers by the interlaminar peeling method stated in interlaminar peeling strength test of laminated paper board according to JIS P 8139 was difficult, the combined sheet sample was immersed in 60° C. water for 1 hour and then the sample was divided into the surface layer, intermediate layer and back layer by peeling. The respective layers thus obtained were dried and the thickness (mm) and basis weight (g/m²) of each of them were determined. Then, the correction factor was calculated as described above, and the thickness of each layer was corrected, and the density of the layer was calculated.

[Extrusion Lamination Method]

Titanium oxide was incorporated into a polypropylene (SunAllomer: a product of MSS) with Labo-plastomill (Toyo Seiki Co., Ltd.) so that the titanium oxide content would be 10% by weight. The obtained mixture was applied to the surface of the base paper to form a synthetic resin layer having a thickness of 30 μm by melt extrusion method. Thus, a base paper for forming vessels was obtained.

An oval-shaped blank sheet was stamped out of the base paper. The blank sheet was radially scored with lines as shown in FIG. 8.

The blank sheet thus obtained was heat-pressed between a pair of upper and lower molds for forming an oval-shaped vessel with a test press molding machine (a product of Dai-Ichi Koki) at 130° C. under 35 kg/cm² to obtain a vessel having a major axis of about 20 cm, minor axis of about 14 cm and height of about 4 cm as shown in FIG. 9.

### <EXAMPLE 5-2>

A molding base paper and then molded paper vessel were produced in the same manner as that of Example 5-1 except that the following three kinds of pulps (1) to (3) were used, that titanium oxide content was changed to 8% by weight, and that the synthetic resin layer having a thickness of 40 μm was formed:

(1) Commercial NBKP having 450 mlcsf, 50 g/m²

(2) Monterey pine TMP having 300 mlcsf/commercial NBKP having 150 mlcsf (70/30), freeness after the combination: 280 mlcsf, 200 g/m²

(3) Commercial NBKP having 450 mlcsf, 50 g/m²

### <REFERENCE EXAMPLE 5-1>

The molding base paper and then molded paper vessel were produced in the same manner as that of Example 5-1 except that only the polypropylene (SunAllomer: a product of MSS) was used without titanium oxide to form a synthetic resin layer having a thickness of 30 μm.

The molded vessel obtained in the Examples and Reference Example were evaluated by the following method:

<Surface Evaluation Method>

The flange or rim of each molded vessel was sampled. A part (20 mm in longitudinal direction) thereof was tested with a micro color difference meter R-30 (Nippon Denshoku Kokyo). The color difference (WB value) was determined at 10 points. The spot diameter was 0.6 mm. When R value (difference between the maximum and the minimum) was 10 points or above, the results were shown by [symbol] and when it was less than 10 points, the results were shown by ∘.

TABLE 7

| | Base paper | | | | | |
|---|---|---|---|---|---|---|
| | | Density | Density | | | |
| | Basis | (outer | (the | | | |
| | weight | layer) | whole) | Synthetic | TiO₂ | |
| | g/m² | g/cm³ | g/cm³ | resin | (wt. %) | Surface |
| Ex. 5-1 | 250 | 0.80 | 0.50 | PP | 10 | ∘ |
| Ex. 5-2 | 300 | 0.80 | 0.60 | PP | 8 | ∘ |
| Ref. | 250 | 0.80 | 0.50 | PP | 0 | x |
| Ex. 1 | | | | | | |

### <EXAMPLE 6-1>

A molding base paper was obtained in the same manner as that of Example 2-1. An aliphatic polyester sheet (trade name: Bionolle, Showa Highpolymer Co., Ltd.) having a thickness of 40 μm was applied to the surface of this base paper by melt extrusion method to form a laminate to be used as a sheet for molding paper vessels.

An oval-shaped blank sheet was stamped out of the base paper. The blank sheet was radially scored with lines as shown in FIG. 8.

The blank sheet was heat-pressed between a pair of upper and lower molds for forming an oval-shaped paper tray with a test press molding machine (a product of Dai-Ichi Koki) at 130° C. under 35 kg/cm² to obtain a vessel having a major axis of about 20 cm, minor axis of about 14 cm and height of about 4 cm as shown in FIG. 9.

### <REFERENCE EXAMPLE 6-1>

A molding paper vessels was obtained in the same manner as that of Example 6-1 except that the aliphatic polyester applied to the surface of the molding base paper to form the laminate was replaced with polypropylene.

The results of the determination and evaluation in the above Example and Comparative Example are shown in Table 8.

The evaluation method was as follows:

[Biodegradability]

The molded paper vessels were buried in the ground in a farm for 6 months and then they were taken out and degree of the decomposition of them was observed.

TABLE 8

| | Laminate | State after keeping in the ground for |
|---|---|---|
| | resin | 6 months |
| Example 6-1 | Aliphatic | The vessel retained only a small |
| | polyester | amount of paper fibers but nothing |
| | | of its original form. |
| Ref. Ex. 6-1 | Polypropylene | The paper partially decomposed and |
| | | the laminate layer completely |
| | | remained. |

As shown in Table 8 above, it is clear that the use of a biodegradable resin as an outer layer for the present base sheet reduces environmental load.

What is claimed is:

1. A molding base paper satisfying the following conditions (1) to (4):
(1) a tensile strength (JIS-P 8113) of at least 2.0 kN/m,
(2) an elongation at break (JIS-P 8113) of at least 1.5%,
(3) a critical compression stress, defined by the following formula, in the range of 1 to 10 MPa:
critical compression stress=A/B
wherein A represents the compression strength determined by JIS-P 8126, and B represents the area of loaded part of the test piece in the determination of the compression strength, and
(4) an amount of compression deformation, caused by applying compression stress of 20 kgf/cm²in thickness direction, of at least 10%.

2. The molding base paper according to claim 1, comprising mechanical pulp.

3. A molding base paper comprising a high density layer and a low density layer, wherein said high density layer has a density of 0.7 to 0.9 g/cm³ and said low-density layer has a density of lower than 0.7 g/cm³, and wherein said base paper has a basis weight of 100 to 500 g/cm² and a density of 0.4 to 0.7 g/cm³.

4. The molding base paper according to claim 3, wherein said low density layer mainly comprising pulp selected from the group consisting of mechanical pulps, curled fibers and mercerized pulps.

5. The molding base paper according to claim 4, wherein said low-density layer is mainly composed of mechanical pulp.

6. The molding base paper according to claim 5, wherein said mechanical pulp is thermomechanical pulp (TMP).

7. The molding base paper according to claims 1 to 6, further comprising a crack preventing layer having an elongation at break of at least 5%, at least one surface thereof.

8. The molding base paper according to claim 7, wherein said elongation at break is at least 6%.

9. The molding base paper according to claim 7, wherein said crack preventing layer has a basis weight of 50 to 150 g/m².

10. The molding base paper according to claims 1 to 9, further comprising a synthetic resin layer on at least one surface thereof.

11. The molding base paper according to claim 10, wherein said synthetic resin is selected from the group consisting of polyethylene, polypropylene, polymethylpentene, polyethylene terephthalate, polybutylene terephthalate, polyamide, ethylene/vinyl alcohol copolymer, polystyrene, and polyacrylonitrile.

12. The molding base paper according to claim 10, wherein said synthetic resin is a biodegradable thermoplastic resin selected from the group consisting of 3-hydroxybutyrate/3-hydroxyvalerate copolymer, 3-hydroxybutyrate polymer, polycaprolactone, polyglycolide, polyvinyl alcohol, polyvinyl alcohol/starch composite, and cellulose derivatives.

13. The molding base paper according to claim 10, wherein said synthetic resin layer further contains a pigment.

14. The molding base paper according to claim 13, wherein said pigment is selected from the group consisting of calcium carbonate, kaolin, clay, talc, titanium oxide, and plastics.

15. A molded paper vessel formed from the molding base paper according to claims 1 to 14 by the drawing.

16. The molded paper vessel according to claim 15, which satisfies the following formula:
0.15≦H/(S2)^{½}
wherein S2 represents the area of the opening at the top of the vessel and H represents the height.
